(19) United States
(12) Patent Application Publication
(10) Pub. No.: US 2007/0159825 A1
(43) Pub. Date: Jul. 12, 2007

(54) Photocatalytic apparatus

(76) Inventor: In Sook Ham, Rancho Pales Verdes, CA (US)

Correspondence Address: WALTER T. KIM;SUITE 1300, 2030 MAIN STREET, IRVINE, CA, 92614, US

(21) Appl. No.: 11/326,667

(22) Filed: Jan. 6, 2006

(51) Int. Cl. F21V 23/02

(52) U.S. Cl. 362/260

(57) ABSTRACT

An apparatus is provided, which has photocatalytic material coated on a surface thereof. The apparatus includes a member adapted to receive irradiation from a light source and a layer of photocatalytic material is formed on a surface of the member. The member having photocatalytic properties is adapted to be disposed in close proximity to the light source. In one embodiment, the photocatalytic member is positioned vertically on top surface of the housing of a fluorescent lamp unit such that the fluorescent tube surrounds the photocatalytic member. In another embodiment, the photocatalytic member is used as a lamp shade or a lamp cover to effectively utilize light emitted by a light source radiating light of appropriate wavelength.

### BACKGROUND OF THE INVENTION

1. Field of the Invention

The present invention generally relates articles having a layer of photocatalytic material formed thereon.

2. Description of the Related Art

There are a number of materials known to exhibit photocatalytic activity, including titanium oxide. When photocatalytic material is exposed to light, the photocatalytic material may be activated, for example, to generate electrons and holes, and this activation may facilitate removal of some of harmful and undesirable substances that may exist in the air.

A variety of processes and articles have been proposed to provide photocatalytic benefits. For example, it has been proposed to apply photocatalyst, such as titanium oxide film, to the outer surface of a fluorescent lamp to provide deodorization and/or cleaning of indoor air. One problem associated with conventional fluorescent lamps coated with titanium oxide film is that the amount of light irradiating from the lamp may be unintentionally reduced by the opaque titanium oxide coating.

### BRIEF SUMMARY OF EMBODIMENTS THE INVENTION

Described herein are various embodiments of an apparatus having photocatalytic material coated on a surface thereof. The apparatus includes a member adapted to receive irradiation from a light source and a layer of photocatalytic material is formed on a surface of the member. According to an embodiment, a photocatalytic member is incorporated into a fluorescent lamp unit so that photocatalytic activity can be achieved to clean indoor air while the fluorescent lamp unit is used to illuminate indoor space. In one embodiment, the fluorescent lamp unit is a compact type fluorescent lamp unit employing a coil type fluorescent tube capable of emitting light with a wavelength in a range of 350 nanometers to 410 nanometers. In one embodiment, the photocatalytic member is positioned vertically on top surface of the housing of the fluorescent lamp unit such that the coil type fluorescent lamp tube surrounds the photocatalytic member. The photocatalytic member may comprise an elongated structure having a coating with photocatalytic properties. In accordance with teaching of one embodiment, because the photocatalytic member is disposed in close proximity (e.g., less than two inches from the light source) to the surrounding coil type fluorescent lamp tube where the illumination is high, such configuration may provide superior photocatalytic activities.

According to an embodiment, a lamp shade comprises a lamp a lamp shade structure having an inner surface and an outer surface, and a layer of photocatalytic material is formed on the inner surface of the lamp shade structure, which faces the light source. In one embodiment, the lamp shade structure is configured to removably attach directly to a housing of a fluorescent lamp. In another embodiment, the lamp shade structure is adapted for use with a light fixture, including table lamps, floor lamps and hanging-type lamp shade assembly. To achieve superior photocatalytic effect, the embodiments of the lamp shades are adapted for used with fluorescent lamps capable of emitting light with a wavelength in a range of 350 nanometers to 410 nanometers. In accordance with teaching of one embodiment, because the embodiments of the lamp shades having photocatalytic properties are adapted to be disposed in close proximity (e.g., less than six inches from a light source) to a light source where the illumination is high, such configuration may provide superior photocatalytic reaction.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1A shows an elevational view of a lamp unit according to one embodiment of the present invention.

FIG. 1B shows a cross-sectional view of a photocatalytic member of FIG. 1A according to one embodiment of the present invention.

FIG. 1C shows a cross-sectional view of a photocatalytic member of FIG. 1A according to another embodiment of the present invention.

FIG. 2A shows an elevational view of a lamp shade mounted on a light fixture according to one embodiment of the present invention.

FIG. 2B shows a cross-sectional view of the lamp shade of FIG. 2A according to one embodiment of the present invention.

FIG. 2C shows a cross-sectional view of the lamp shade of FIG. 2A according to another embodiment of the present invention.

FIG. 3A shows an elevational view of a hanging-type lamp shade according to one embodiment of the present invention.

FIG. 3B shows a cross-sectional view of the lamp shade of FIG. 3A according to one embodiment of the present invention.

FIG. 3C shows a cross-sectional view of the lamp shade of FIG. 3A according to another embodiment of the present invention.

FIG. 4A shows an elevational view of a lamp shade to cover a fluorescent lamp according to one embodiment of the present invention.

FIG. 4B shows a cross-sectional view of the lamp shade of FIG. 4A according to one embodiment of the present invention.

FIG. 4C shows a cross-sectional view of the lamp shade of FIG. 4A according to another embodiment of the present invention.

### DETAILED DESCRIPTION OF THE INVENTION

In the following description, specific details are set forth in order to provide a thorough understanding of various embodiments of the present invention. However, it will be apparent to one skilled in the art that embodiments of the present invention may be practiced without these specific details. In other instances, well-known hardware and software components, structures and techniques have not been shown in detail in order to avoid obscuring embodiments of the present invention. It should be noted that, as used in the description herein and the claims, the meaning of “in” includes “in” and “on”.

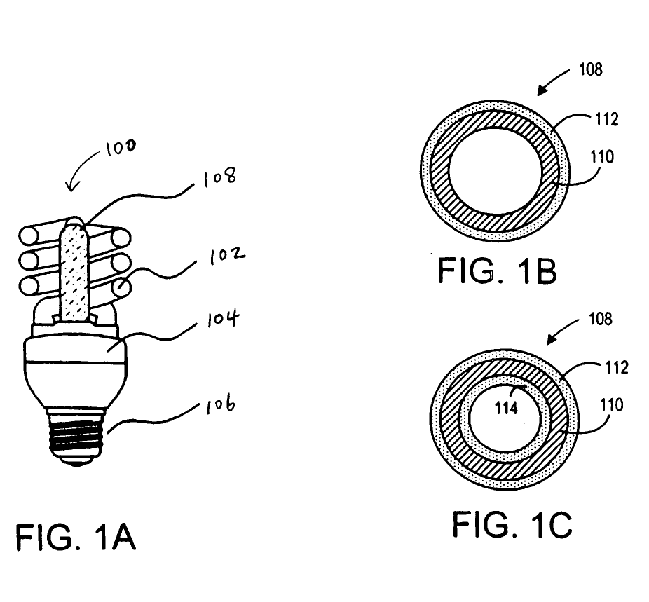

FIG. 1A depicts a fluorescent lamp unit 100 according to one embodiment of the present invention, with portions of the fluorescent tube 102 broken away. The lamp unit 100 generally includes a housing 104 that supports a fluorescent lamp tube element. The fluorescent lamp tube element comprises at least one fluorescent tube 102, a base portion and electrical contacts. Attached to neck portion of the housing 104 is an electrically conductive base 106. The conductive base 106 may be a conventional screw-in socket which includes threads for threadedly engaging with a conventional electrical lamp socket. The conductive base 106 includes a first contact terminal and a second contact terminal positioned on the base so as to establish contact with contacts of the lamp socket when the conductive base is received in the lamp socket. To drive the fluorescent tube 102, the lamp unit 100 includes a circuit coupled between the electrical contacts of the fluorescent lamp tube element and the first and second contact terminals of the base. The circuit may include a ballast and optionally a starter coupled between the fluorescent tube element and the conductive base 106.

Although in the illustrated embodiment, a coil type fluorescent tube 102 is shown, it should be understood that other types of fluorescent lamp tube having different shapes and sizes may also be used, including a U-shaped lamp tube and a circular lamp tube. The fluorescent lamp unit 100 is preferably capable of emitting light with a wavelength in the range from 350 nanometers to 420 nanometers, more preferably in the range from 380 nanometers to 400 nanometers.

Further included in the lamp unit 100 is a photocatalytic member 108 attached to the upper surface of the housing 104. In the illustrated embodiment, the photocatalytic member 108 is positioned on the lamp unit 100 such that the coil type fluorescent lamp tube 102 surrounds the photocatalytic member 109. The photocatalytic member 108 comprises an elongated structure 110, which is preferably disposed vertically with respect to the housing 104. The photocatalytic member 108 is formed by covering at least a part of the outer surface of the underlying elongated structure 110 with a layer of photocatalytic material 112, as shown in FIG. 1B. Preferably, at least 90% of the outer surface of the underlying structure 110 is covered with the photocatalytic material 112, and more preferably the entire outer surface of the underlying element 110 is covered with the photocatalytic material 112. The underlying elongated element 110 may be solid or hollow and made of glass, ceramic, plastic, metal, fibrous material or any combination thereof.

In an alternative embodiment, both the inner surface and the outer surface of the elongated structure 110 are covered with a layer of photocatalytic material to effectively utilize light applied by the fluorescent lamp tube 102. In this regard, the photocatalytic member 101 includes a first photocatalytic layer 112 formed on the outer surface of the elongated structure 110 and a second photocatalytic layer 114 formed on the inner surface of the elongated structure 110, as shown in FIG. 1C.

In one embodiment, the photocatalytic layer 102 is a thin film of photocatalytic material that contains titanium oxide as a primary component. The titanium oxide used in the photocatalytic layer 102 is preferably crystallized in the anatase form. In addition to the titanium oxide, the photocatalytic layer 102 may optionally contain other materials that may increase the photocatalytic effect of the titanium oxide. The photocatalytic member 108 preferably does not contain any light source capable of emitting light. Additionally, the photocatalytic member 108 is preferably disposed in close proximity to the fluorescent tube 102 where illumination is high but the member 108 is preferably separated from the fluorescent tube 102.

One advantage of coating the elongated structure 110, which is separate from the fluorescent tube, with photocatalytic material is that the titanium oxide coating providing the photocatalytic benefits does not reduce the amount of light irradiating from the fluorescent tube. As noted above, one problem associated with conventional fluorescent lamps coated with titanium oxide film is that the amount of light irradiating from the lamp may be reduced by the opaque titanium oxide coating.

The cleaning of the indoor air is achieved by irradiating the photocatalytic layer 112 formed on the elongated element 110 with the light generated by the fluorescent tube element of the lamp unit 100. The exposure to light causes activation of the photocatalytic properties of the photocatalytic layer 112 to facilitate removal of some of harmful and undesirable substances that may exist in the air space proximal to the photocatalytic member 108. Because the photocatalytic member 108 is disposed in close proximity (e.g., less than two inches from the fluorescent tube) to the light source where the illumination is high, such configuration may provide superior photocatalytic activities. Furthermore, because the heat generated by the lamp unit 100 may cause air to flow into and out of the region surrounding the photocatalytic member 108, such air circulation may facilitate to effectively clean a greater amount of indoor air existing in the surrounding space occupied by the fluorescent lamp unit 100.

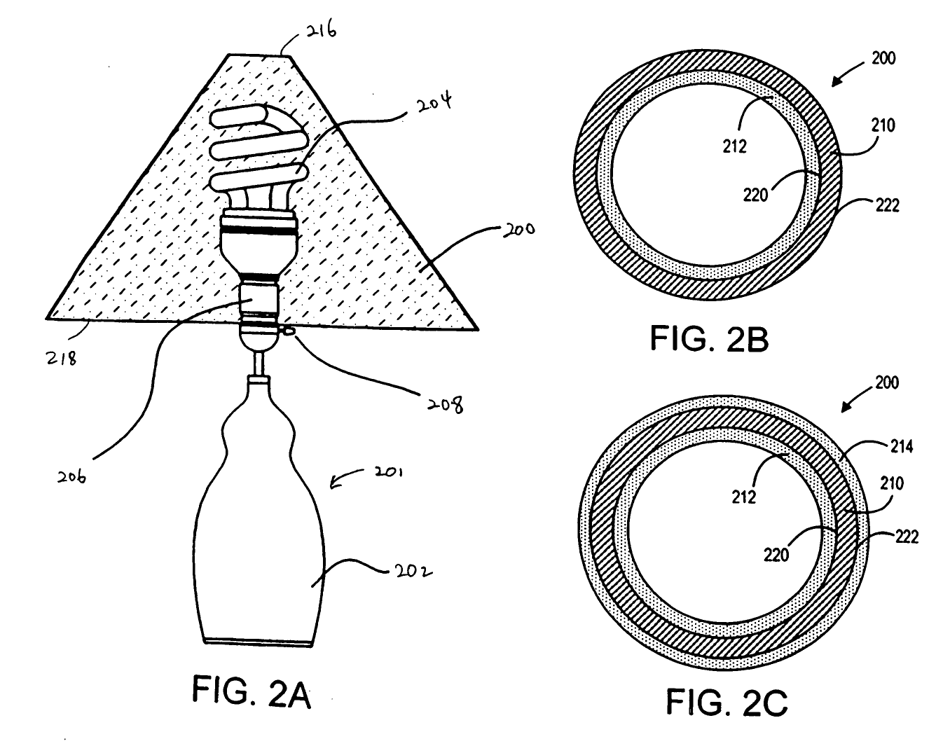

FIG. 2A depicts a lamp shade 200 according to one embodiment of the present invention. In one embodiment, the lamp shade 200 is configured for use with a light fixture 201, such as, for example, a table lamp, as illustrated in FIG. 2A. In this context, the term “table lamp” is used to describe any portable lamp which can be placed on tables, desks, or other horizontal surface. The lamp shade 200 described with reference to FIG. 2A may also be used with a floor lamp adapted to stand on a floor.

The illustrated table lamp 201 includes a base stand 202, a socket 206, a control switch 208 and a lamp 204 received in the socket 206. The table lamp 201 is preferably used with a light source, such as a fluorescent lamp 204, which is capable of emitting light with a wavelength in the range from 350 nanometers to 420 nanometers, and more preferably in the range from 380 nanometers to 400 nanometers.

In the illustrated embodiment, the fluorescent lamp 204 is surrounded by a round conical shade 200, which is open at the top 216 and the bottom 218. The lamp shade 200 comprises a lamp shade structure 210 (shown in FIGS. 2B and 2C) made of a suitable transparent or translucent material, including plastic, glass and ceramic. Alternatively, the lamp shade structure 210 is constructed of fibrous material, including translucent cloth or paper supported by a frame. The lamp shade 200 may further include a mounting member coupled to the lamp shade structure 210 to removably attach or mount the shade structure to the light fixture 201 or to the lamp 204.

In accordance with one embodiment of the present invention, the lamp shade 200 is constructed by coating a layer of photocatalytic material on a surface of the lamp shade structure 210, which faces the light source 204. As shown in FIG. 2B, a photocatalytic layer 212 is formed on the inner surface 220 of the lamp shade structure 210. In one embodiment, at least 90% of the inner surface 220 of the lamp shade structure 210 is provided with a layer of photocatalytic material, and more preferably the entire inner surface 220 of the lamp shade structure 210 is covered with the photocatalytic layer 212.

In an alternative embodiment, both the inner surface 220 and the outer surface 222 of the lamp shade structure 210 are covered with a layer of photocatalytic material. In this regard, the lamp shade 200 includes a first photocatalytic layer 212 formed on the inner surface 220 of the lamp shade structure 210 and a second photocatalytic layer 214 formed on the outer surface 222 of the lamp shade structure 210, as shown in FIG. 2C. Accordingly, in this embodiment, the lamp shade 200 effectively utilizes light applied to the lamp shade from the inside and outside thereof.

In one embodiment, the photocatalytic layers 212 and 214 contain titanium oxide. The titanium oxide is preferably used as a primary component in the photocatalytic layers 212 and 214, and is preferably crystallized in the anatase form. By crystallizing titanium oxide in anatase form, a preferable orientation of the titanium oxide crystal growth may be achieved to provide superior photocatalytic properties. In addition to the titanium oxide, the photocatalytic layers 212 and 214 may optionally contain other materials that may increase the photocatalytic effect of the titanium oxide.

One advantage of coating the lamp shade structure 210, which is separate from the light source, with photocatalytic material is that the titanium oxide coating providing the photocatalytic activities does not reduce the amount of light irradiating from the fluorescent tube. As noted above, one problem associated with conventional fluorescent lamps coated with titanium oxide film is that the amount of light irradiating from the lamp may be reduced by the opaque titanium oxide coating.

The cleaning of the indoor air is achieved by exposing the photocatalytic layer 212 formed on the inner surface 220 of the lamp shade 200 to the light irradiating from the fluorescent lamp 204. The exposure to light causes activation of the photocatalytic properties to facilitate removal of some of harmful and undesirable substances that may exist in the air space defined by the lamp shade 200. Because the lamp shade 200 having the photocatalytic layer is disposed in close proximity (e.g., less than six inches from the fluorescent tube) to the light source where the illumination is high, such configuration may provide superior photocatalytic activities. Additionally, the heat generated by the fluorescent lamp 204 may cause air below the lamp shade 200 to flow upward into the air space defined by the lamp shade 200 and flow out of the top opening 216. Thus, the lamp shade 200 advantageously serves to break down harmful and undesirable substances as the air flows in and out of the air space defined thereby.

It should be noted that although the embodiments of the lamp shades, described herein, are preferably used with fluorescent lamps (e.g., compact fluorescent lamps and fluorescent tubes), it should be noted that the embodiments of lamp shades described herein may be used with other types of light producing apparatus, including incandescent lamps.

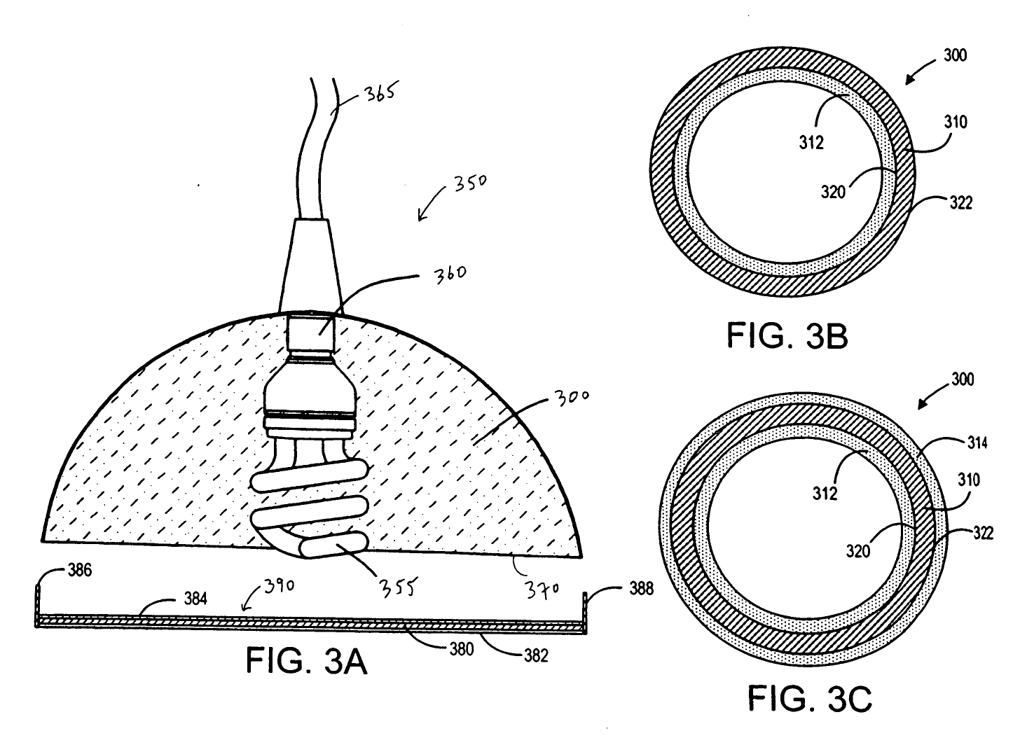

FIG. 3A depicts a lamp shade 300 for a hanging-type lamp shade assembly 350 according to one embodiment of the present invention. The hanging-type lamp shade assembly 350 includes a lamp socket 360 coupled to a power cord 365 and a hanging-type lamp shade 300 suspended from the bottom of the power cord. The hanging-type lamp shade assembly 350 is preferably used with a light source 355, such as a fluorescent lamp, which is capable of emitting light with a wavelength in the range from 350 nanometers to 420 nanometers and more preferably in the range from 380 nanometers to 400 nanometers.

As shown in FIG. 3A, the illustrated lamp shade 300 is bowl-shaped, which is open at the bottom 370. In accordance with one embodiment of the present invention, at least a portion of the bowl-shaped lamp shade 200 is covered with a layer of photocatalytic material. The lamp shade 300 comprises a lamp shade structure 310 (shown in FIGS. 3B and 3C) made of a suitable transparent or translucent material, including plastic, glass, and ceramic. Alternatively, the lamp shade structure 310 is constructed of fibrous material, including translucent cloth or paper supported by a frame.

In accordance with one embodiment of the present invention, the lamp shade 300 is constructed by coating a layer of photocatalytic material on a surface of the lamp shade structure 310, which faces the light source 355. As shown in FIG. 3B, a photocatalytic layer 312 is formed on the inner surface 320 of the lamp shade structure 310. In one embodiment, at least 90% of the inner surface 320 of the lamp shade structure 310 is provided with a layer of photocatalytic material, and more preferably the entire inner surface 320 of the lamp shade structure 310 is covered with the photocatalytic layer 312.

In an alternative embodiment, both the inner surface 320 and the outer surface 322 of the lamp shade structure 310 are covered with a layer of photocatalytic material to effectively utilize light applied to the lamp shade from the inside and outside thereof. In this regard, the lamp shade 300 includes a first photocatalytic layer 312 formed on the inner surface 320 of the lamp shade structure 310 and a second photocatalytic layer 314 formed on the outer surface 322 of the lamp shade structure 310, as shown in FIG. 3C. In one embodiment, the photocatalytic layers 312 and 314 contain titanium oxide. The titanium oxide is preferably used as a primary component in the photocatalytic layers 312 and 314, and is preferably crystallized in the anatase form. In addition to the titanium oxide, the photocatalytic layers 312 and 314 may optionally contain other materials that may increase the photocatalytic effect of the titanium oxide.

In use, the photocatalytic layer 312 formed on the inner surface 320 of the lamp shade 300 is exposed to the light irradiating from the fluorescent lamp 355. The exposure to light causes activation of the photocatalytic properties to facilitate removal of some of harmful and undesirable substances that may exist in the air proximal to the lamp shade 300. The lamp shade 300 advantageously serves to break down harmful and undesirable substances that exist in the surrounding space as the air flows in and out through the bottom opening 370 of the lamp shade 300.

As shown in FIG. 3A, the lamp shade 300, in one embodiment, includes a member 390 configured to attach to the bottom portion thereof to close the bottom opening 370. The member 390 comprises a flat or curved structure 380 having a first photocatalytic layer 382 formed on the surface which faces away from the light source and a second photocatalytic layer 384 formed on the surface which faces the light source. The member 390 may includes attachment members 386, 388 to allow the member 390 to be removably attach to the lamp shade 300. Alternatively, the member 390 and the lamp shade 300 can be constructed as a single integral structure.

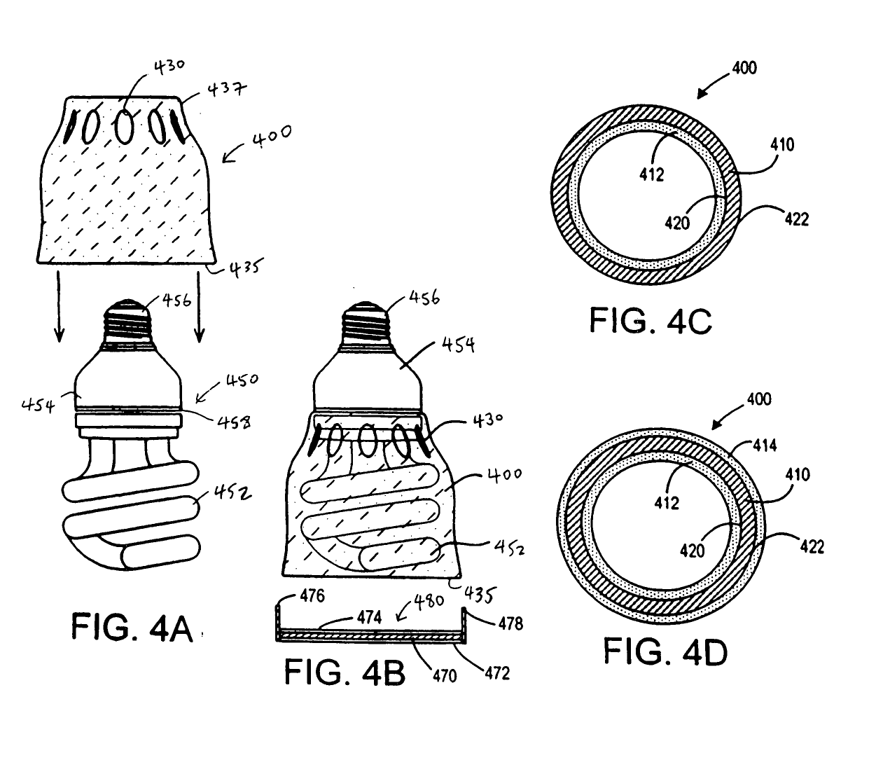

FIG. 4A and 4B depict a lamp cover 400 to cover a fluorescent lamp 450 according to one embodiment of the present invention. The fluorescent lamp 450 generally includes a housing 454 that supports a fluorescent lamp tube element. The fluorescent lamp tube element comprises at least one fluorescent tube 452, a base portion and electrical contacts. Attached to neck portion of the housing 454 is an electrically conductive based 456. The conductive based 456 may be a conventional screw-in socket which includes threads for threadedly engaging with a conventional electrical lamp socket. The lamp cover 400 (also referred herein as “lamp shade”) comprises a lamp cover structure 410 (shown in FIGS. 4C and 4C) made of a suitable transparent or translucent material, including plastic, glass, and ceramic. The illustrated lamp cover 400 has an opened form, which is open at the bottom 435.

In one embodiment, the top portion 437 of the lamp cover 400 includes a number of openings 430, which serves as a vent to allow air to flow upward and out of lamp cover 400. The lamp cover 400 also includes a mounting element (not shown) which is configured to detachably attach to a portion of the fluorescent lamp housing 454. In one implementation, the top portion 437 of the lamp cover 400 is provided with female threads on the inner surface thereof for matably engaging with male threads 458 formed on the outer surface the fluorescent lamp housing 454 to removably attach the lamp cover 400 to the fluorescent lamp 450, as shown in FIG. 4B.

In accordance with one embodiment of the present invention, the lamp cover 400 is constructed by coating a layer of photocatalytic material on a surface of the lamp cover structure 410, which faces the fluorescent lamp 450. As shown in FIG. 4B, a photocatalytic layer 412 is formed on the inner surface 420 of the lamp cover structure 410. In one embodiment, at least 90% of the inner surface 420 of the lamp cover structure 410 is provided with a layer of photocatalytic material, and more preferably the entire inner surface 420 of the lamp cover structure 410 is covered with the photocatalytic layer 412.

In an alternative embodiment, both the inner surface 420 and the outer surface 422 of the lamp cover structure 410 are covered with a layer of photocatalytic material to effectively utilize light applied to the lamp cover from the inside and outside thereof. In this regard, the lamp cover 400 includes a first photocatalytic layer 412 formed on the inner surface 420 of the lamp cover structure 410 and a second photocatalytic layer 414 formed on the outer surface 422 of the lamp cover structure 410, as shown in FIG. 4C. In one embodiment, the photocatalytic layers 412 and 414 contain titanium oxide. The titanium oxide is preferably used as a primary component in the photocatalytic layers 412 and 414 and is preferably crystallized in the anatase form. In addition to the titanium oxide, the photocatalytic layers 412 and 414 may optionally contain other materials that may increase the photocatalytic effect of the titanium oxide.

In use, the photocatalytic layer 412 formed on the inner surface 420 of the lamp cover 400 is exposed to the light from the fluorescent lamp 450. The exposure to light causes activation of the photocatalytic properties to facilitate removal of some of harmful and undesirable substances that may exist in the air space contained within the lamp cover 400. Because the lamp cover 400 having the photocatalytic film is disposed in close proximity (e.g., less than two inches from the fluorescent tube) to the light source where the illumination is high, such configuration may provide superior photocatalytic activities. Additionally, the heat generated by the lamp 450 may cause air below the lamp cover 400 to flow upward into the lamp cover and flow out of the openings 430 formed at the top portion of the lamp cover 400. Thus, the lamp cover 400 advantageously serves to break down harmful and undesirable substances as the air flows in and out of the space defined by the lamp cover 400.

As shown in FIG. 4B, the lamp cover 400, in one embodiment, includes a member 480 configured to attach to the bottom portion thereof to close the bottom opening 435. The member 480 comprises a flat or curved structure 470 having a first photocatalytic layer 472 formed on the surface which faces away from the light source (i.e., fluorescent lamp tube 452) and a second photocatalytic layer 474 formed on the surface which faces the light source. The lamp cover 400 and the member 480 may be constructed as two separate structures which are subsequently joined together. In the illustrated embodiment, the member 480 includes attachment members 476, 478 to allow the member 480 to be removably attach to the fluorescent lamp 450. Alternatively, the member 390 and the lamp cover 300 can be constructed as a single integral structure. In one embodiment, the lamp cover 400 is permanently attached to the fluorescent lamp 450 during manufacturing thereof.

It should be noted that the embodiments of the lamp shades and lamp cover shown and described with references to FIGS. 2, 3 and 4 are but several examples of shapes and types of lamp shades and lamp covers that can be constructed in accordance with the present invention to provide photocatalytic benefits. It is understood that the embodiments of the lamp shades and lamp cover described herein are not limited to any specific shapes or sized, but are generally applicable to any suitable types of lamp shades and lamp covers, including upwardly opening bowl-shaped lamp shades. Additionally, it should further be noted that the table lamp shown and described with reference to Figure 2A is but one example of a type of light fixture that can be used with the embodiments of lamp shades described herein. It is understood that the embodiments of the lamp shades described herein are not limited for use with any one specific type of light fixture, but is generally applicable to any suitable types of light fixtures, including floor lamps with upwardly opening bowl-shaped lamp shade and floor lamps with round conical lamp shade.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. An apparatus comprising:
a member adapted to receive irradiation from a light source; and
a layer of photocatalytic material formed on at least a portion of a surface of the member.

2. The apparatus of claim 1, wherein the photocatalytic layer comprises titanium oxide.

3. The apparatus of claim 1, wherein the member comprises a lamp shade structure having an inner surface and an outer surface; and
the layer of photocatalytic material formed on the inner surface of the lamp shade structure.

4. The apparatus of claim 3, further comprising:
a layer of photocatalytic material formed on the outer surface of the lamp shade structure.

5. The apparatus of claim 1, wherein the light source is a fluorescent lamp comprising a fluorescent tube supported by a housing; and
wherein the member is a lamp cover configured to attach to the housing of the fluorescent lamp.

6. The apparatus of claim 1, wherein the light source is a fluorescent lamp comprising a coil type fluorescent tube supported by a housing; and
wherein the member comprises an elongated structure and the photocatalytic layer covering an outer surface of the elongated structure, the elongated structure disposed vertically with respect to the housing of the fluorescent lamp such that the coil type fluorescent lamp tube surrounds the elongated structure.

7. A lamp shade comprising:
a lamp shade structure having an inner surface and an outer surface; and
a layer of photocatalytic material formed on the inner surface of the lamp shade structure.

8. The lamp shade of claim 7, wherein the photocatalytic layer comprises titanium oxide.

9. The lamp shade of claim 7, further comprising:
a layer of photocatalytic material formed on the outer surface of the lamp shade structure.

10. The lamp shade of claim 7, wherein the lamp shade structure is configured to attach directly to a housing of a fluorescent lamp.

11. The lamp shade of claim 10, wherein the lamp shade structure includes a plurality of openings to allow air to flow in and out of space defined by the lamp shade structure.

12. The lamp shade of claim 7, wherein the lamp shade structure has a round conical shape, which is open at the top and the bottom.

13. The lamp shade of claim 7, wherein the lamp shade structure has a downwardly opening bowl-shape.

14. A fluorescent lamp unit comprising:
a housing having a lower end and an upper end;
a fluorescent tube element supported by the housing;
a photocatalytic member supported by the housing;
an electrically conductive base attached to the lower end of the housing to mate with a lamp socket; and
a circuit coupled between the fluorescent tube element and the conductive base to drive the fluorescent tube

15. The fluorescent lamp unit of claim 14, wherein the fluorescent tube element is configured to emit light with a wavelength in the range from 390 nanometers to 420 nanometers.

16. The fluorescent lamp unit of claim 14, wherein the photocatalytic member is separated from the fluorescent tube.

17. The fluorescent lamp unit of claim 14, wherein the photocatalytic member comprises:
an elongated element; and
a layer of photocatalytic material formed on at least a portion of the elongated element.

18. The fluorescent lamp unit of claim 17, wherein the photocatalytic layer comprises titanium oxide.

19. The fluorescent lamp unit of claim 18, wherein the elongated element is disposed vertically with respect to the housing.

20. The fluorescent lamp unit of claim 14, wherein the fluorescent tube is a coil type fluorescent lamp tube.

21. The fluorescent lamp unit of claim 20, wherein the photocatalytic member is positioned with respect to the fluorescent tube such that the coil type fluorescent lamp tube surrounds the photocatalytic member.

22. The fluorescent lamp unit of claim 14, wherein the electrically conductive base includes a first contact terminal and a second contact terminal positioned on the base so as to establish electrical contact with socket contacts of the lamp socket when the base is received in the lamp socket.

23. A method comprising:
providing a photocatalytic member having a layer of photocatalytic material formed on a surface thereof; and
positioning the photocatalytic member in close proximity to a fluorescent lamp capable emitting light with a wavelength in a range from 380 nanometers to 400 nanometers.

24. The method of claim 23, wherein positioning comprises positioning the photocatalytic member within two inches from the light source.

25. The method of claim 24, wherein positioning comprises positioning the photocatalytic member on an upper surface of a housing of a fluorescent lamp unit such that the photocatalytic member is surrounded by the fluorescent lamp tube of the fluorescent lamp unit.

26. The method of claim 23, wherein the photocatalytic member is a lamp shade having a layer of photocatalytic material formed on an inner surface facing a light source, and
wherein positioning the photocatalytic member comprises attaching the lamp shade to a light fixture.

27. The method of claim 23, wherein the photocatalytic member is a lamp cover having a layer of photocatalytic material formed on an inner surface facing a light source, and
wherein positioning the photocatalytic member comprises attaching the lamp shade to a housing of the fluorescent lamp.
